(19) United States
(12) Patent Application Publication
(10) Pub. No.: US 2024/0055989 A1
(43) Pub. Date: Feb. 15, 2024

(54) TWO STAGE VOLTAGE CONVERTER FOR HIGH EFFICIENCY OPERATION

(71) Applicant: MAXIM INTEGRATED PRODUCTS, INC., San Jose, CA (US)

(72) Inventors: Cory Brent ARNOLD, Tempe, AZ (US); Justin Michael BURKHART, Bolton, MA (US)

(21) Appl. No.: 18/268,095

(22) PCT Filed: Dec. 29, 2021
(86) PCT No.: PCT/US2021/065506

§ 371 Date: Jun. 16, 2023

Related U.S. Application Data
(60) Provisional application No. 63/133,640, filed on Jan. 4, 2021.

(51) Int. Cl. H02M 3/158; H02M 3/07

(52) U.S. Cl. CPC H02M 3/158; H02M 3/072; H02M 1/32

(57) ABSTRACT

A voltage converter includes: first and second switches having a first voltage rating, the first switch connected between an input voltage and a first node, and the second switch connected between the first node and a potential; a bypass switch connected between the input voltage and a second node; a first inductor connected between the first node and the second node; a first capacitor connected between the second node and the potential; third and fourth switches having a second voltage rating that is less than the first voltage rating, the third switch connected between the second node and a third node, and the fourth switch connected between the third node and the potential; and a switch control module configured to, in response to the input voltage becoming greater than a predetermined voltage: switch the first and second switches and adjust the voltage at the second node toward a target voltage.

### CROSS REFERENCE TO RELATED APPLICATIONS

This application claims the benefit of U.S. Provisional Application No. 63/133,640, filed on Jan. 4, 2021. The entire disclosure of the application referenced above is incorporated herein by reference.

### FIELD

The present disclosure relates to voltage converters and more particularly to buck voltage converters.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Vehicles include various components. For example, some vehicles include an engine that combusts air and fuel to generate drive torque for propulsion. An alternator converts mechanical energy from rotation of the engine into electrical energy for use by the vehicle. For example, electrical energy from the alternator can be used to recharge a battery. Additionally or alternatively, electrical energy from the alternator can be used to power various vehicle accessories, such as lights, etc.

Under some circumstances, the battery of the vehicle can be electrically disconnected from the alternator. For example, the battery of the vehicle can be electrically disconnected from the alternator when the vehicle collides with another object, such as a vehicle, a lane divider, a barrier, etc.

### SUMMARY

In a feature, a voltage converter includes: first and second switches having a first voltage rating, the first switch connected between an input voltage and a first node, and the second switch connected between the first node and a potential; a bypass switch connected between the input voltage and a second node; a first inductor connected between the first node and the second node; a first capacitor connected between the second node and the potential; third and fourth switches having a second voltage rating that is less than the first voltage rating, the third switch connected between the second node and a third node, and the fourth switch connected between the third node and the potential; and a switch control module configured to, in response to the input voltage becoming greater than a predetermined voltage: open the bypass switch; and complementarily switch the first and second switches to regulate the voltage at the second node toward a target voltage.

In further features, the voltage converter further includes a second capacitor and a second inductor, where: the second inductor is connected between the third node and an output node; and the second capacitor is connected between the output node and the potential.

In further features, the predetermined voltage is one of greater than and equal to the target voltage.

In further features, the predetermined voltage is less than the second voltage rating of the third and fourth switches.

In further features, the switch control module is configured to complementarily switch the first and second switches at a frequency of at least 2 megahertz.

In further features, the switch control module is configured to complementarily switch the first and second switches at a frequency that is less than or equal to 8 megahertz.

In further features, the switch control module is configured to, when the input voltage is less than the predetermined voltage, open the first and second switches and close the bypass switch.

In further features, the switch control module is further configured to complementarily switch the third and fourth switches based on adjusting a voltage at an output node toward or to a target voltage.

In further features, the switch control module is configured to complementarily switch the third and fourth switches based on adjusting the voltage at the output node toward or to the target voltage while complementarily switching the first and second switches.

In further features, the target voltage is less than the second voltage rating.

In further features, the target voltage is between 1 and 9 volts, inclusive.

In further features, the first voltage rating is at least 30 volts and the second voltage rating is at least 12 volts.

In further features, the first voltage rating is greater than the target voltage at the second node.

In further features, the second voltage rating is greater than the target voltage at the second node.

In further features, the first, second, third, and fourth switches are field effect transistors (FETs).

In further features, the voltage converter further includes a capacitor connected between the third node and a fifth node, where the fourth switch is connected between the fifth node and the potential.

In further features, the voltage converter further includes: a fifth switch connected between the third node and an output node; and a sixth switch connected between the fifth node and the output node.

In further features, the voltage converter further includes an output capacitor connected between the output node and the potential.

In further features, the fifth and sixth switches having the second voltage rating that is less than the first voltage rating.

In further features, the switch control module is configured to: open the third and sixth switches while the fourth and fifth switches are closed; and open the fourth and fifth switches while the third and sixth switches are closed.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example voltage control system of a vehicle;

FIG. 2 includes a schematic of an example implementation of a voltage converter;

FIG. 3 is a schematic of an example implementation of a voltage converter having a single stage;

FIG. 4 is a graph of efficiency versus load current;

FIG. 5 is a graph of power dissipation versus load current;

FIG. 6 is a flowchart depicting an example method of controlling the voltage converter; and

FIG. 7 includes a schematic of an example implementation of a voltage converter.

In the drawings, reference numbers may be reused to identify similar and/or identical elements.

### DETAILED DESCRIPTION

A voltage converter converts an input voltage to a target output voltage. For example, a buck voltage converter generates an output voltage from the input voltage that is less than the output voltage. A boost voltage converter generates an output voltage from the input voltage that is greater than the output voltage.

The voltage converter could include a single stage of switches that have voltage ratings that are sufficient to survive a transient increase in the input voltage. For example, the voltage converter could include switches that have 36 volt DC voltage ratings in various implementations, such as in vehicular implementations. Single stage voltage converters, however, may have decreased efficiency relative to two stage voltage converters.

The present application involves a two stage voltage converter. A first stage includes first switches with a first voltage rating, and a second stage includes switches with second voltage ratings that are less than the first voltage ratings. The first switches (and the first voltage rating) are sufficient to survive a maximum increase in an input voltage. If the input voltage becomes greater than a predetermined voltage, a switch control module switches the first switches to decrease a voltage input to the second stage to a target that is less than the second voltage rating of the switches of the second stage. The switch control module switches the second switches to achieve a target output voltage. The two stage voltage converter is more electrically efficient than a single stage voltage converter.

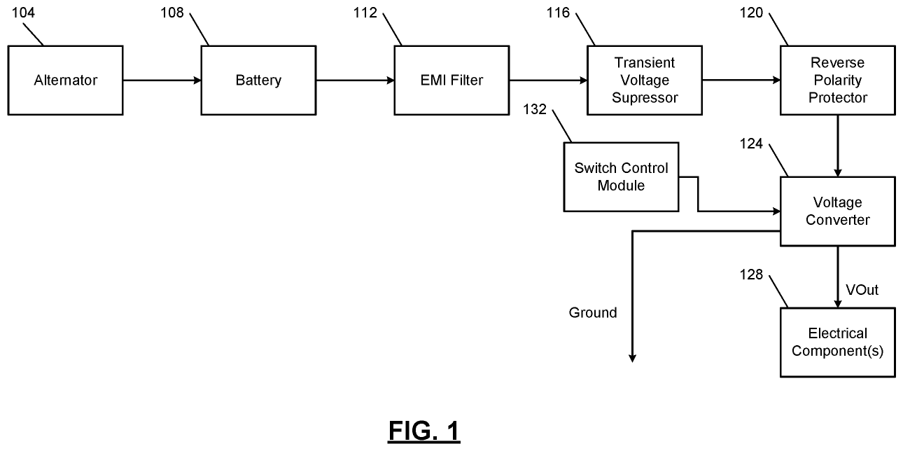

FIG. 1 is a functional block diagram of an example voltage control system of a vehicle. While the example of the voltage control system being implemented in a vehicle will be provided, the present application is also applicable to non-vehicle applications, such as industrial applications.

An alternator 104 converts mechanical energy (e.g., rotation of a crankshaft of an engine) into electrical energy, such as to charge a battery 108. The battery 108 may be, for example, a 12 volt direct current (DC) battery or a battery having another suitable voltage rating.

An electromagnetic interference (EMI) filter 112 performs EMI filtering of an output of the battery 108. A transient voltage suppressor 116 limits the voltage to a reverse polarity protector 120 to a predetermined maximum voltage, such as approximately 35-42 volts DC or another suitable maximum voltage. The reverse polarity protector 120 protects against improper (reverse) connection to terminals of the battery 108. For example, the reverse polarity protector 120 may open (electrically) when the battery 108 is connected improperly.

A voltage converter 124 is connected to an output of the reverse polarity protector 120 and receives an input voltage (Vin), such as from the reverse polarity protector 120. The voltage converter 124 generates an output voltage (Vout) from the input voltage using voltage conversion. For example, the output voltage is less than the input voltage in the example of the voltage converter 124 including a buck voltage converter or greater than the input voltage in the example of the voltage converter 124 including a boost voltage converter. One or more electrical components 128, such as vehicle accessories, lights, etc. operate using the output voltage of the voltage converter 124.

The voltage converter 124 includes a first stage including first and second switches that have a first voltage rating. The voltage converter 124 also includes a second stage including third and fourth switches having a second voltage rating that is less than the first voltage rating.

A switch control module 132 controls switching of the switches of the voltage converter 124. The switch control module 132 switches the third and fourth switches to generate the output voltage from the input voltage. The switch control module 132 switches the first and second switches to discharge the input voltage to a potential, such as a ground potential, for example, when the input voltage is greater than a predetermined load dump voltage, such as when the battery 108 becomes disconnected from the alternator 104 or when one or more other load dump events occur. Written differently, when the input voltage becomes greater than the predetermined load dump voltage, the switch control module 132 switches the first and second switches to decrease voltage input to the second stage to a target that is less than the voltage rating of the third and fourth switches. The predetermined load dump voltage is greater than the second voltage rating of the third and fourth switches.

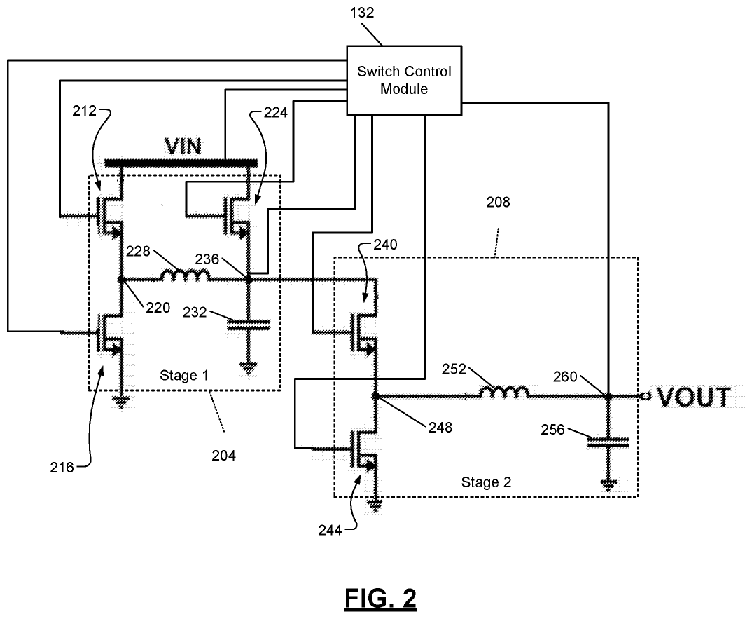

FIG. 2 includes a schematic of an example implementation of the voltage converter 124. The voltage converter 124 includes a first stage 204 and a second stage 208. The first stage 204 includes a first switch 212 and a second switch 216. The first and second switches 212 and 216 have a first voltage rating. The first voltage rating may be, for example, approximately 36 volts direct current (DC) or another suitable voltage that is greater than the voltage rating of the battery 108. Voltage ratings discussed herein may be expressed in terms of voltage between the input and output terminals (e.g., source and drain terminals) of a switch. Approximately may mean +/−10%. The first and second switches 212 and 216 are sized to be large enough to be sufficient to survive an automotive load dump event.

The first switch 212 is connected between a node receiving the input voltage (Vin) and a first node 220. The second switch 216 is connected between the first node 220 and a ground potential. While the example of a ground potential is provided, the present application is also applicable to positive and negative potentials.

The first stage 204 also includes a bypass switch 224, a first inductor 228, and a first capacitor 232. The bypass switch 224 is connected between the node receiving the input voltage (Vin) and a second node 236. The first inductor 228 is connected between the first node 220 and the second node 236. The first capacitor 232 is connected between the second node 236 and the ground potential.

The second stage 208 includes a third switch 240 and a fourth switch 244. The third and fourth switches 240 and 244 have a second voltage rating that is less than the first voltage rating. For example only, in the example of the first and second switches 212 and 216 having a first voltage rating of approximately 36 volts DC, the third and fourth switches 240 and 244 may have a voltage rating of approximately 18 volts DC or another suitable voltage rating. The second voltage rating is greater than the input voltage (Vin) under normal operating conditions.

While examples of the first and second stages 204 and 208 are provided, one or more components may be arranged differently.

The third switch 240 is connected between the second node 236 and a third node 248. The fourth switch 244 is connected between the third node 248 and the ground potential.

The second stage 208 also includes a second inductor 252 and a second capacitor 256. The second inductor 252 is connected between the third node 248 and an output node 260. The output voltage (Vout) is output via the output node 260. The second capacitor 256 is connected between the output node 260 and the ground potential.

The first, second, third, fourth, and bypass switches 212, 216, 240, 244, and 224 may be field effect transistors (FETs) or another suitable type of switch.

The switch control module 132 controls switching of the first, second, third, fourth, and bypass switches 212, 216, 240, 244, and 224. During normal operation, the switch control module 132 maintains the first and second switches 212 and 216 open and closes the bypass switch 224. This connects the input voltage (Vin) to the second node 236. The switch control module 132 controls switching of the third and fourth switches 240 and 244 to adjust the output voltage (Vout) at the output node 260 to a target output voltage. The target output voltage may be a fixed predetermined value or may be a variable. The target output voltage may be, for example, approximately 1-9 volts DC or another suitable target output voltage. Examples of target output voltages include 1.2 volts DC, 3.3 volts DC, 5 volts DC, etc.

The switch control module 132 complementarily switches the third and fourth switches 240 and 244. As used herein, complementarily switching of two switches may mean closing one of the two switches while opening the other one of the two switches, and vice versa. The two switches are not closed at the same time. However, the two switches may both be open for a predetermined (e.g., deadtime) period before one of the switches is closed.

The output voltage increases when the third switch 240 is closed and the fourth switch 244 is open. The output voltage decreases when the third switch 240 is open and the fourth switch 244 is closed.

A load dump event may be said to occur when the input voltage (Vin) is greater than the predetermined load dump voltage (which may also referred to as a load dump voltage protection threshold) that is greater than the first predetermined voltage for normal operating conditions (e.g., 12 volts DC). The predetermined load dump voltage may be, for example, 15 volts DC or another suitable voltage. The predetermined load dump voltage may be less than, equal to, or greater than the second voltage rating of the third and fourth switches 240 and 244.

When the input voltage is greater than the predetermined load dump voltage, the switch control module opens the bypass switch 224 and complementarily switches the first and second switches 212 and 216 to regulate the voltage at the second node 236 and input to the third and fourth switches 240 and 244 to a second target voltage. With the complementary switching, when one of the first and second switches 212 and 216 is closed, the other one of the first and second switches 212 and 216 is open and vice versa. The first and second switches 212 and 216 are not both closed at the same time. However, the switch control module 132 may switch the first and second switches 212 and 216 such that both of the first and second switches 212 and 216 are open at the same time, such as for a deadtime period before closing one of the first and second switches 212 and 216.

The second target voltage is less than the first voltage rating of the first and second switches 212 and 216. The second target voltage may also be less than the second voltage rating of the third and fourth switches 240 and 244. The voltage at the second node 236 increases when the first switch 212 is closed and the second switch 216 is open. The voltage at the second node 236 decreases when the first switch 212 is open and the second switch 216 is closed. The switch control module 132 may continue to complementarily switch the third and fourth switches 240 and 244 to adjust the output voltage toward or to the target output voltage while complementarily switching the first and second switches 212 and 216.

The switch control module 132 may switch (closing of) the first and second switches 212 at a predetermined switching frequency. The predetermined frequency may be, for example, between 2 megahertz (MHz) and 8 MHz or another suitable frequency. The predetermined frequency being between 2 and 8 MHz may minimize or prevent interference in vehicular applications. The predetermined switching frequency of the first and second switches 212 may allow for the inductance and physical size of the first inductor 228 to be minimized. The predetermined switching frequency may be a fixed predetermined frequency or variable.

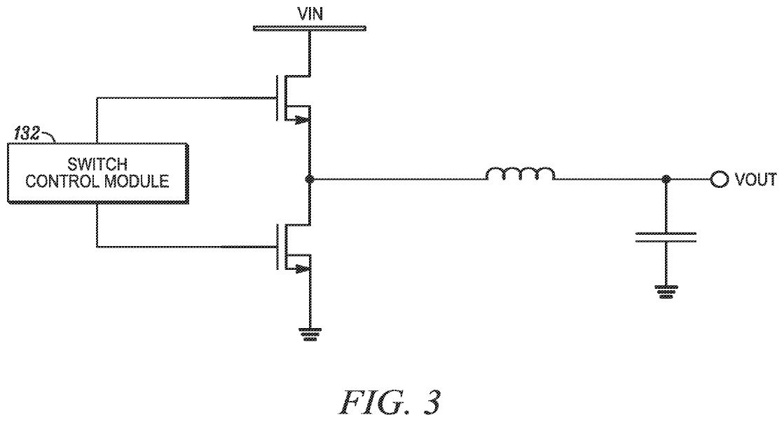

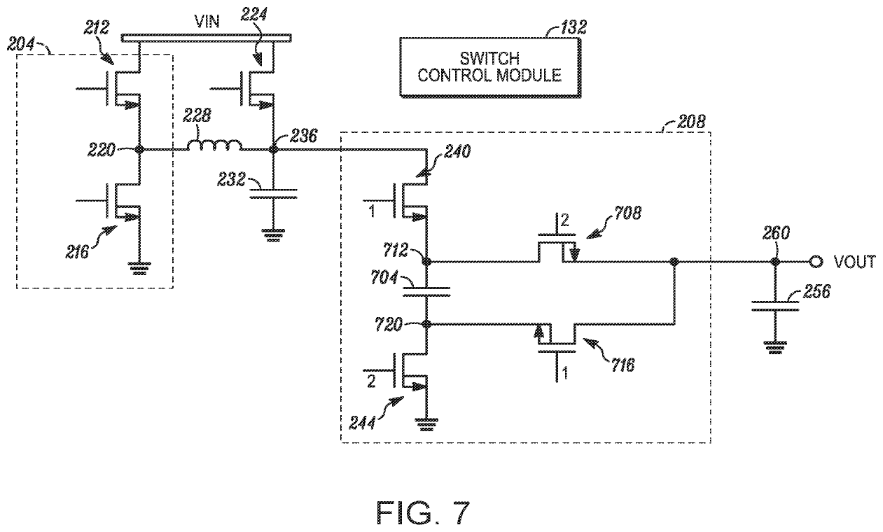

As an alternative to the example of FIG. 2, FIG. 3 includes a single stage example including switches that have voltages ratings that are sufficient to survive a load dump event without the second stage. For example, the switches of FIG. 3 may have the first voltage rating, and the switch control module 132 may control the switches to decrease the voltage to the target output voltage. The example of FIG. 3, however, is less efficient and consumes more energy than the examples of FIGS. 2 and 7. The examples of FIGS. 2 and 7 may also be less costly than the example of FIG. 3 and be physically smaller in size (e.g., area or volume) than the example of FIG. 3.

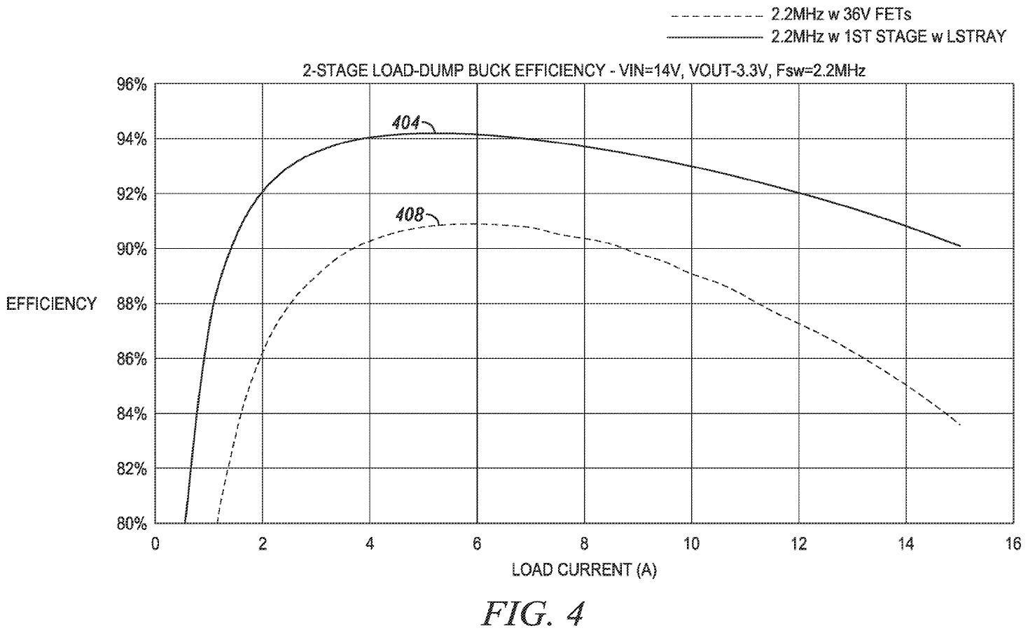

FIG. 4 includes an example graph of efficiency versus load current. Trace 404 tracks the efficiency of the example of FIG. 2 during normal operation with an input voltage (Vin) of 14 volts DC an output voltage (Vout) of 3.3 volts DC. Trace 408 tracks the efficiency of the example of FIG. 3 during normal operation with an input voltage (Vin) of 14 volts DC an output voltage (Vout) of 3.3 volts DC. As illustrated by FIG. 4, the example of FIG. 2 is more efficient and consumes less power than the example of FIG. 3.

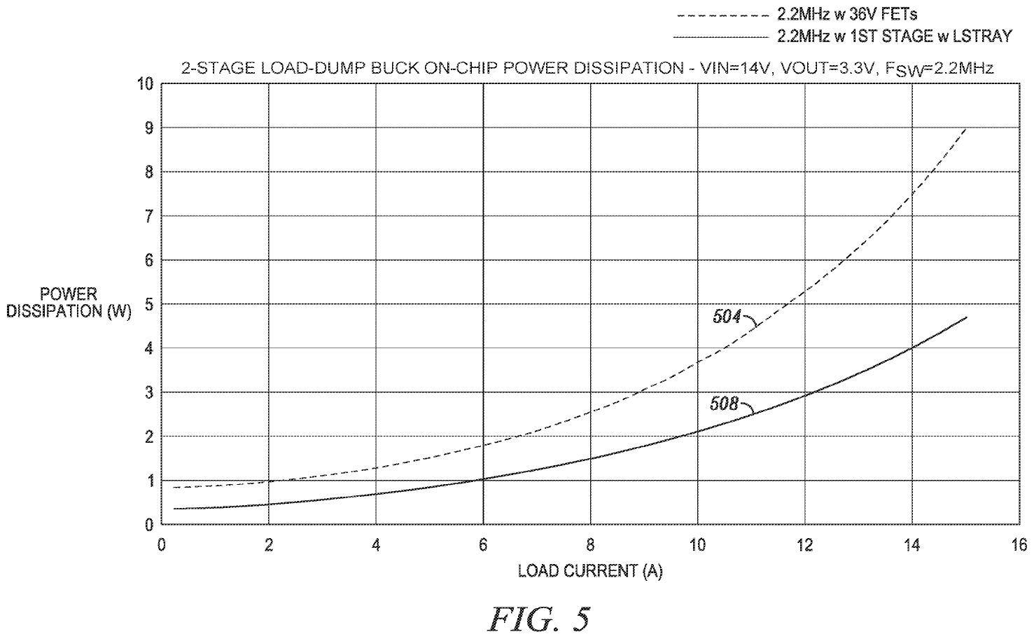

FIG. 5 includes an example graph of power dissipation versus load current. Trace 504 tracks the power dissipation of the example of FIG. 2 with an input voltage (Vin) of 14 volts DC an output voltage (Vout) of 3.3 volts DC. Trace 508 tracks the power dissipation of the example of FIG. 3 with an input voltage (Vin) of 14 volts DC an output voltage (Vout) of 3.3 volts DC.

While the example of FIG. 2 is illustrated as including a buck converter in the second stage, the present application is also applicable to other types of voltage converters. For example, the second stage may include a boost converter or a buck/boost converter. Also, while the example of FIG. 2 provides a single level/phase, the second stage may include a multi-level/phase voltage converter and output multiple different target output voltages.

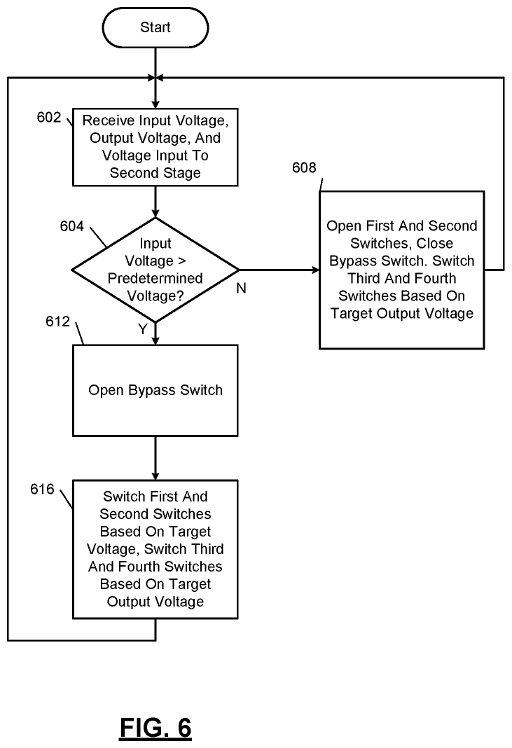

FIG. 6 is a flowchart depicting an example method of controlling the voltage converter 124. Control begins with 602 where the switch control module 132 receives the input voltage (Vin) and the output voltage (Vout). The switch control module 132 may also receive the voltage to the second stage 208, i.e., the voltage at the second node 236. These voltages may be, for example, measured using voltage sensors.

At 604, the switch control module 132 determines whether the input voltage is greater than the predetermined load dump voltage. If 604 is false, control proceeds with 608. At 608, the switch control module 132 opens the first and second switches 212 and 216 or maintains the first and second switches 212 and 216 open. The switch control module 132 also closes the bypass switch 224 at 608. The switch control module 132 also complementarily switches the third and fourth switches to adjust the output voltage (Vout) toward or to the target output voltage at 608. Control returns to 602. If 604 is true, control continues with 612.

At 612, the switch control module 132 opens the bypass switch 224. At 616, the switch control module 132 complementarily switches the first and second switches 212 and 216 to decease the input voltage toward or to the second target voltage to the second stage 208. The switch control module 132 also complementarily switches the third and fourth switches to adjust the output voltage (Vout) toward or to the target output voltage at 616. Control returns to 602.

FIG. 7 is a functional block diagram of an example voltage converter. In the example of FIG. 7, the second stage 208 includes a switched capacitor converter. A capacitor 704 is connected between the third and fourth switches 240 and 244. A fifth switch 708 is connected between (a) a node 712 between the third switch 240 and a first end of the capacitor 704 and (b) the output node 260. A sixth switch 716 is connected between (a) a node 720 between a second end of the capacitor 704 and the fourth switch 720 and (b) the output node 260.

The first switch 212 and the second switch 216 have the first voltage rating, as discussed above, such as approximately 36 volts direct current (DC) or another suitable voltage that is greater than the voltage rating of the battery 108. The third, fourth, fifth, and sixth switches 240, 244, 708, and 712 have a second voltage rating that is less than the first voltage rating. For example only, in the example of the first and second switches 212 and 216 having a first voltage rating of approximately 36 volts DC, the third, fourth, fifth, and sixth switches 240, 244, 708, and 712 may have a voltage rating of approximately 18 volts DC or another suitable voltage rating. The second voltage rating is greater than the input voltage (Vin) under normal operating conditions.

The switch control module 132 controls switching of the first, second, and bypass switches 212, 216, and 214, as discussed above. The switch control module 132 controls the third, fourth, fifth, and sixth switches in two phases using a clock. The two phases may each have an approximately 50% duty cycle and be completely out of phase with each other such that the switches of the first phase are off/open when the switches of the second phase are on/closed and vice versa. The third and sixth switches 240 and 216 may be on/closed in the first phase, and the fourth and fifth switches 244 and 708 may on/closed in the second phase. The fourth and fifth switches 244 and 708 may be on/closed in the first phase, and the third and sixth switches 240 and 216 may on/closed in the second phase. The switches of the first and second phases are complementarily switched.

In the first phase, the switch control module 132 closes the third and sixth switches 240 and 716 and opens the fourth and fifth switches 244 and 708. In the first phase, the capacitor 704 is in series with the output capacitor 256 and the capacitor 704 is charged. In the second phase, the switch control module 132 closes the fourth and fifth switches 244 and 708 and opens the third and sixth switches 2540 and 716. In the second phase, the capacitor 704 is in parallel with the output capacitor 256 and the capacitor 704 discharges to the output capacitor 256.

In equilibrium, the output voltage of the second stage 208 may be equal to approximately one-half of the input voltage to the second stage 208 (the voltage at node 236). While one example configuration of a switched capacitor converter is provided, the present application is also applicable to other switched capacitor configurations including switch capacitor configurations that include multiple flying capacitors, switch capacitor configurations that include step-up converter ratios, and switched capacitor configurations that include step-down converter ratios. The fifth and sixth switches 708 and 716 may be the same type of switches as the third and fourth switches 240 and 244, such as FETs.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A voltage converter, comprising:
first and second switches having a first voltage rating, the first switch connected between an input voltage and a first node, and the second switch connected between the first node and a potential;
a bypass switch connected between the input voltage and a second node;
a first inductor connected between the first node and the second node;
a first capacitor connected between the second node and the potential;
third and fourth switches having a second voltage rating that is less than the first voltage rating, the third switch connected between the second node and a third node, and the fourth switch connected between the third node and the potential; and
a switch control module configured to, in response to the input voltage becoming greater than a predetermined voltage:
open the bypass switch; and
complementarily switch the first and second switches to regulate the voltage at the second node toward a target voltage.

2. The voltage converter of claim 1 further comprising a second capacitor and a second inductor, wherein:
the second inductor is connected between the third node and an output node; and
the second capacitor is connected between the output node and the potential.

3. The voltage converter of claim 1 wherein the predetermined voltage is one of greater than and equal to the target voltage.

4. The voltage converter of claim 1 wherein the predetermined voltage is less than the second voltage rating of the third and fourth switches.

5. The voltage converter of claim 1 wherein the switch control module is configured to complementarily switch the first and second switches at a frequency of at least 2 megahertz.

6. The voltage converter of claim 1 wherein the switch control module is configured to complementarily switch the first and second switches at a frequency that is less than or equal to 8 megahertz.

7. The voltage converter of claim 1 wherein the switch control module is configured to, when the input voltage is less than the predetermined voltage, open the first and second switches and close the bypass switch.

8. The voltage converter of claim 1 wherein the switch control module is further configured to complementarily switch the third and fourth switches based on adjusting a voltage at an output node toward or to a target voltage.

9. The voltage converter of claim 8 wherein the switch control module is configured to complementarily switch the third and fourth switches based on adjusting the voltage at the output node toward or to the target voltage while complementarily switching the first and second switches.

10. The voltage converter of claim 8 wherein the target voltage is less than the second voltage rating.

11. The voltage converter of claim 10 wherein the target voltage is between 1 and 9 volts, inclusive.

12. The voltage converter of claim 1 wherein the first voltage rating is at least 30 volts and the second voltage rating is at least 12 volts.

13. The voltage converter of claim 1 wherein the first voltage rating is greater than the target voltage at the second node.

14. The voltage converter of claim 1 wherein the second voltage rating is greater than the target voltage at the second node.

15. The voltage converter of claim 1 wherein the first, second, third, and fourth switches are field effect transistors (FETs).

16. The voltage converter of claim 1 further comprising a capacitor connected between the third node and a fifth node,
wherein the fourth switch is connected between the fifth node and the potential.

17. The voltage converter of claim 16 further comprising:
a fifth switch connected between the third node and an output node; and
a sixth switch connected between the fifth node and the output node.

18. The voltage converter of claim 17 further comprising an output capacitor connected between the output node and the potential.

19. The voltage converter of claim 17 wherein the fifth and sixth switches having the second voltage rating that is less than the first voltage rating.

20. The voltage converter of claim 17 wherein the switch control module is configured to:
open the third and sixth switches while the fourth and fifth switches are closed; and
open the fourth and fifth switches while the third and sixth switches are closed.
